(19) United States
(12) Patent Application Publication
(10) Pub. No.: US 2006/0284735 A1
(43) Pub. Date: Dec. 21, 2006

(54) Data presentation systems and methods

(76) Inventors: Michael Ip, Fremont, CA (US); Yancy Chen, Campbell, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/154,112

(22) Filed: Jun. 15, 2005

(51) Int. Cl. G05B 19/02

(52) U.S. Cl. 340/825.69; 340/825.22

(57) ABSTRACT

A remote control comprises a receiver operable to receive a data set, a presentation device coupled to the receiver and operable to present information derived from the data set, and a transmitter coupled to the presentation device and operable to transmit a signal operable to control an electronic device.

### BACKGROUND

Remote controls for televisions, stereo systems and other electronic devices are well known in the art. Also well known is the universal remote control that is capable of controlling multiple devices of different types and makes.

Many universal remote controls in use today include both a microprocessor and some type of display, such as a liquid-crystal display (LCD), which may provide information such as, for example, the type of device controlled. However, notwithstanding the inclusion of these versatile components, these remote controls generally serve only to control devices.

### SUMMARY

In an embodiment of the invention, a remote control comprises a receiver operable to receive a data set, a presentation device coupled to the receiver and operable to present information derived from the data set, and a transmitter coupled to the presentation device and operable to transmit a signal operable to control an electronic device.

### BRIEF DESCRIPTION OF THE DRAWINGS

FIG. 1 is a schematic view of a system according to an embodiment of the invention.

FIG. 2 is a front plan view of an electronic system according to an embodiment of the invention.

FIG. 3 is a functional block diagram of the system illustrated in FIG. 1.

FIG. 4 is a flow diagram of a method according to an embodiment of the invention.

### DETAILED DESCRIPTION

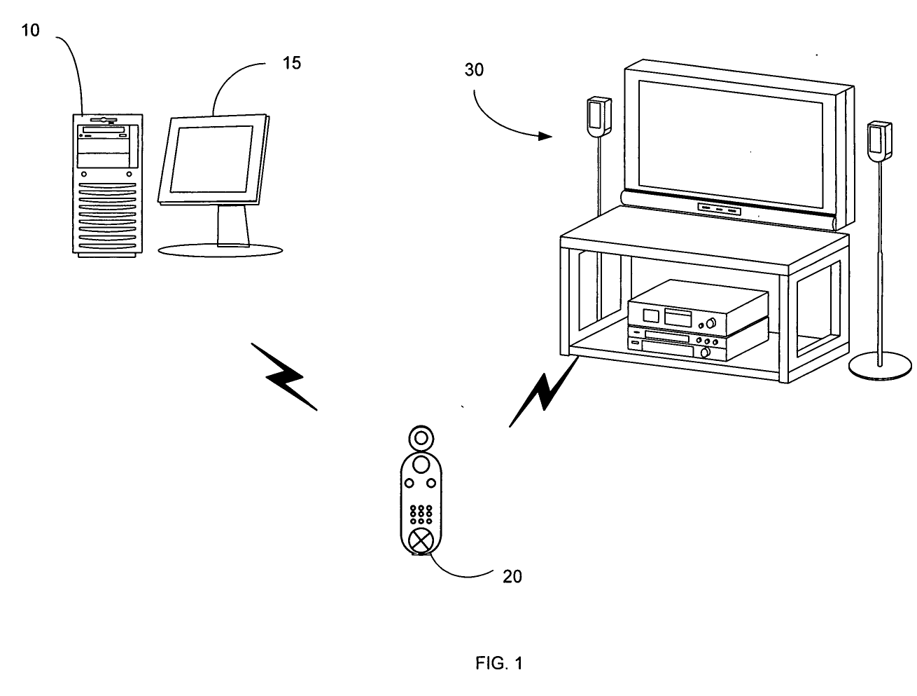

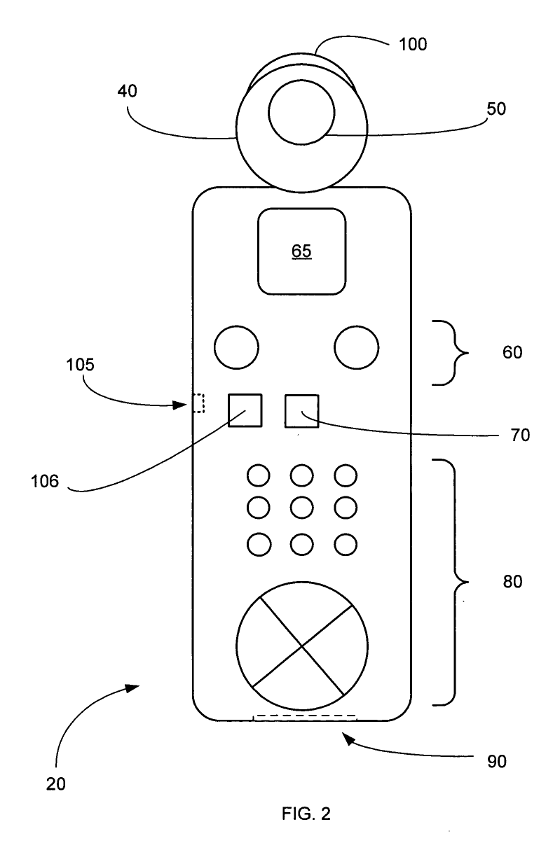

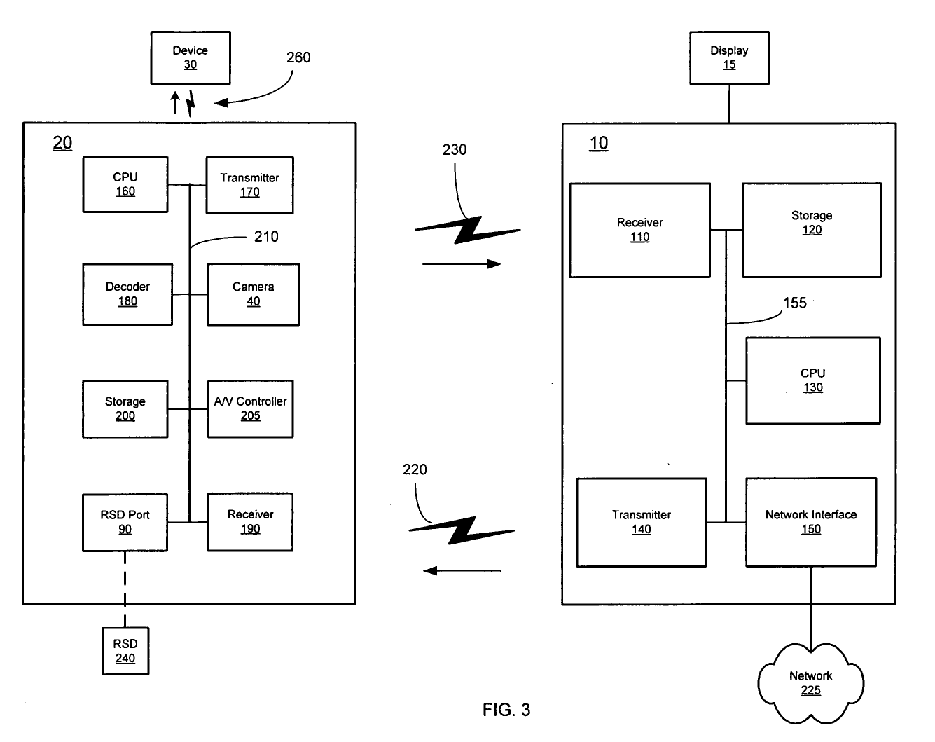

FIG. 1 is a schematic view of an electronic device such as a general-purpose computer 10 coupled to a display 15 and a remote control 20, according to an embodiment of the invention. As discussed more fully with reference to FIGS. 2 and 3, the remote control 20 is operable to control operation of the computer 10, display 15, and one or more electronic devices 30. The devices 30 may include, for example, televisions, stereo receivers, multimedia recording devices, and any other electronic device controllable by remote-control signals. In addition, the remote control 20 may be operable to exchange data, such as digital content, with the computer 10.

Referring to FIG. 2, according to an embodiment of the invention, the remote control 20 includes a camera module 40 having a camera lens 50, and a set of camera controls 60 (e.g., zoom/pan, shoot, etc.). A presentation device, such as a display 65, which may include a LCD screen, may allow a user of the remote control 20 to see saved and/or real-time images captured by the camera module 40. As discussed below, the display 65 may further allow a user of the remote control 20 to view still and/or streaming images transmitted by the computer 10.

The remote control 20 may further include a microphone 70 that records sound to accompany images captured by the camera module 40 or that otherwise allows the remote control 20 to serve as a digital sound recorder.

The remote control 20 may further include a set of device controls 80, such as, for example, left/right, up/down, volume-control and channel-selection buttons, which are typical of known universal remote controls and allow communication with the computer 10, control over an electronic device 30, and navigation through items, such as, for example, a graphical user interface (not shown), displayed on the display 65.

The remote control 20 may further include a removable storage device (RSD) port 90 and a transmitter interface 100, such as an infrared lens, located on the camera module 40.

The remote control 20 may further include a presentation device, such as an audio jack 105. When used in conjunction with headphones or other types of speakers (not shown), the audio jack 105 allows a user of the remote control 20 to hear, for example, audio files transmitted to the remote control 20 by the computer 10. In addition or alternatively to the audio jack 105, the remote control 20 may include a presentation device, such as an audio speaker 106 that also enables a user of the remote control 20 to hear audio files.

Referring to FIG. 3, according to an embodiment of the invention, the computer 10 includes the following components: a receiver 110, a storage device 120 (such as a hard disk drive), a processor such as a central processing unit (CPU) 130, a transmitter 140, and a network interface 150. A bus 155 couples these computer components to one another. In an alternative embodiment, the receiver 110 and/or transmitter 140 may be peripheral devices coupled to the computer 10.

The remote control 20 further includes the following components: a processor such as a CPU 160, a transmitter 170, a decoder 180, a receiver 190, a storage device 200, and an audio/video (AN) controller 205 according to an embodiment of the invention. A bus 210 couples these remote-control components to one another. Alternatively, these remote-control components may be coupled by conventional wired or wireless connection(s) other than the bus 210.

The decoder 180 serves to decode data received, as discussed in further detail below, from the computer 10. As depicted, the decoder 180 may be implemented as a hardware component. Alternatively, or in addition, software decoding may be used. The decoder 180 may use various algorithms, such as Moving Pictures Experts Group (MPEG) or Voice over IP (VolP), for decoding.

The A/V controller 205 is provided to convert digital audio/video signals into analog signals for display/playback on the display 65, speaker 106, and/or headphones via the jack 105. The A/V controller 205 may be implemented using one or more physical devices, such as separate graphics and sound hardware.

According to an embodiment of the invention, the computer 10 is operable to transmit data sets to the receiver 190 of the remote control 20 via signals 220 emitted by the transmitter 140. These data sets may include, for example, software application data, television-channel guide, stored audio/video files, CD/DVD cover artwork and/or information; lyrics, video previews, previews of television channels, closed-caption information, subtitle information, alternate language/soundtracks that may be heard via headphone (not shown) or the like, stored playlists, downloaded menus of selectable media files, information including sports scores/headlines/stock prices/weather, and/or other media files including audio, video or text files. Additionally, these data sets may be stored in the storage device 120 or otherwise may be retrieved by the computer 10, via the network interface 150, from a server or other computer on or coupled to a network 225, such as a local-area network, wide-area network or the Internet. The signals 220 may be infrared (IR) signals, radio frequency (RF) signals, or any other wireless signals. Alternatively, a physical connection (e.g. cable) may carry the signals 220.

In operation, the computer 10 may transmit to the remote control 20 a software-application data set that, when executed by the CPU 160, is output to the display 65 in the form of a menu or other graphical user interface (not shown). Such a menu may list data sets (e.g., photographs, songs, movies, etc.) that can be received from the computer 10 and be presented by the display 65, speaker 106 and/or headphones (not shown) via the jack 105 of the remote control 20. By employing the device controls 80 (FIG. 2), the user may make one or more selections from the menu using a cursor. The transmitter 170 of the remote control 20 may then transmit, via the transmitter interface 100, the selection as signals 230 to the receiver 110 of the computer 10. The signals 230 may likewise be IR signals, RF signals, or any other wireless signals. Alternatively, a physical connection may carry the signals 230.

In response to receiving the selection from the remote control 20, the CPU 130 of the computer 10 may retrieve the data set corresponding to the selection and cause the data set to be transmitted to the receiver 190 of the remote control 20.

The data set may be processed by the decoder 180 and/or ANV controller 205 to produce a medium (e.g., audio, visual, textual, etc.) or multimedia output that can be presented by the display 65, speaker 106, and/or headphones (not shown) via the jack 105 as appropriate.

According to an embodiment of the invention, and referring to FIGS. 2 and 3, the camera module 40, in combination with the CPU 160, provides a fully functional digital still-image and movie camera employing an image sensor (not shown) including, for example, a charge coupled device (CCD) or complementary metal oxide semiconductor (CMOS) technology. It should be noted that, as used herein, the term “photograph” refers to either a still image or video movie. In operation, according to an embodiment of the invention, a user of the remote control 20 takes photographs by orienting the camera lens 50 (FIG. 2) toward a target object and using the camera controls 60 (FIG. 2). Each photograph taken by the camera module 40 may be stored in a RSD 240, such as a solid-state compact flash device, coupled to the RSD port 90. Each such photograph may also be viewed on the LCD screen 65.

Alternatively, after taking photographs with the remote control 20, the user may wish to upload the photographs to the computer 10 for storage and/or viewing purposes. According to an embodiment, the user wirelessly transmits photographs, via the signals 230, from the transmitter 170 of the remote control 20 to the receiver 110 of the computer 10. Alternatively, the user may transmit photographs to the computer 10 over a physical connection, such as a cable (not shown).

According to an embodiment, the remote control 20 may function as a universal remote control in a manner known in the art. Accordingly, the remote control 20 may control operation of a device 30 by emitting wireless control signals 260, via the transmitter 170, to a device 30. Alternatively, a physical connection may carry the signals 260.

Still referring to FIG. 3, the network interface 150 may include an interface device, such as, for example, a public switched telephone network (PSTN) interface card, which allows the computer 10 to communicate over a telephone network known in the art, which may be included by the network 225. Accordingly, the transmitter 140 may transmit to the receiver 190 signals received from the telephone network that a user can ultimately hear as sound via the speaker 106 or headphones (not shown) via the jack 105. In addition, the transmitter 170 may transmit to the receiver 110 signals received from the microphone 70 that the computer 10 may then transmit over the telephone network. As such, the remote control 20 may serve the user as a cordless-telephone handset with the computer 10 serving as the corresponding cordless-telephone base.

According to an embodiment, the remote control 20 may execute a voice recognition program that allows a user of the remote control 20 to control the computer 110, a device 30, or functions of the remote control 20, itself, with minimal user keystrokes to the device controls 80 (FIG. 2). For example, the storage device 200 may store audio files, such as, for example, .wav files, associated with verbal commands that correspond to keypad commands (e.g., ¢channel up,” “volume down,” ”power off,” etc.) that a user may employ to control a device 30. The user may then initiate the voice-recognition feature by, for example, activating one of the controls 80 and speaking a verbal command into the microphone 70. The CPU 160 may then compare the spoken command to the stored audio files, identify the audio file associated with the spoken command, and cause the transmitter 170 to issue the corresponding command to the device 30.

Other embodiments of the arrangement shown in FIGS. 1, 2 and 3 are contemplated. For example, the remote control 20 and computer 10 may respectively include more or fewer than all of the components illustrated in FIGS. 2 and 3.

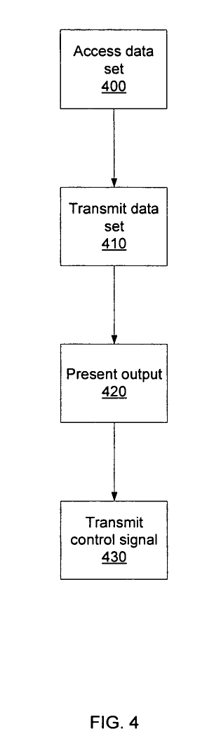

FIG. 4 illustrates a process of operating the remote control 20 of FIGS. 1, 2 and 3 according to an embodiment of the invention. Beginning at a step 400, the computer 10 accesses a data set selected by the remote control 20. At a step 410, the computer 10 transmits the data set to the remote control 20. Subsequently, at a step 420, the remote control 20 presents output, such as, for example, video and/or audio, produced from the data set, via the display 65, speaker 106 and/or headphones (not shown) via the jack 105 of the remote control 20. At a step 430, the remote control 20 emits command signals 260 to which the computer 10 and/or device 30 responds.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. For example, it should be recognized that all operations described herein as applying to photographs at least similarly apply to digital sound recordings captured by the remote control 20 using the microphone 70. Thus, the present invention is not intended to be limited to the embodiments shown, but is to be accorded the widest scope consistent with the principles and features disclosed herein.

What is claimed is:

1. A remote-control unit, comprising:
a receiver operable to receive a data set;
a presentation device coupled to the receiver and operable to present information derived from the data set; and
a transmitter coupled to the presentation device and operable to transmit a signal operable to control an electronic device.

2. The unit of claim 1 wherein the receiver is operable to receive the data set from the electronic device.

3. The unit of claim 1 wherein the presentation device comprises a display.

4. The unit of claim 1 wherein the presentation device comprises a speaker.

5. The unit of claim 1, further comprising a processor coupled to the receiver and presentation device and operable to derive the information from the data set.

6. The unit of claim 1, further comprising a camera module operable to capture an image.

7. The unit of claim 1, further comprising a microphone operable to capture a sound.

8. The unit of claim 7 wherein the transmitter is further operable to transmit to an electronic device an audio signal produced by the microphone.

9. The unit of claim 1 wherein the electronic device comprises a stereo receiver.

10. The unit of claim 1, further comprising a sensor operable to receive a verbal command issued by a user, wherein the transmitter transmits the signal in response to the sensor receiving the verbal command.

11. The unit of claim 1 wherein the data set comprises a stream of video data.

12. The unit of claim 1 wherein the data set comprises an audio file.

13. The unit of claim 1 wherein the receiver is operable to receive-the data set over a wireless channel.

14. A system, comprising:
a processing device operable to access a data set; and
a remote control operable to receive the data set from the processing device, to derive information from the data set, to present the derived information, and to control an electronic device.

15. The system of claim 14 wherein the processing device comprises the electronic device.

16. The system of claim 14 wherein the processing device is operable to receive the data set from a remote server.

17. The system of claim 14 wherein the processing device accesses the data set in response to receiving a signal from the remote control.

18. The system of claim 14 wherein the processing device is operable to transmit signals produced by the remote control over a telephone network.

19. A method, comprising:
accessing a data set;
transmitting the data set to a remote control; and
with the remote control, deriving information from the data set, presenting the information produced from the data set, and controlling an electronic device.

20. A method, comprising:
receiving, with a remote control, a data set;
deriving, with the remote control, information from the data set;
presenting the derived information via a presentation device of the remote control; and
controlling an electronic device with the remote control.

21. A remote-control unit, comprising:
means for receiving a data set;
means for deriving information from the data set;
means for presenting the derived information; and
means for controlling an electronic device.
